(19) United States
(12) Patent Application Publication
(10) Pub. No.: US 2004/0044642 A1
(43) Pub. Date: Mar. 4, 2004

(54) Apparatus, method and program for managing database logs

(75) Inventors: Hisaya Fujii, Kanagawa (JP); Mitsuhiro Kinomura, Kanagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/375,020

(22) Filed: Feb. 28, 2003

(30) Foreign Application Priority Data
Aug. 16, 2002 (JP) 2002-237234

(51) Int. Cl. G06F 9/00; G06F 17/30

(52) U.S. Cl. 707/1; 718/101; 718/102

(57) ABSTRACT

An apparatus for managing database logs provides more efficient system operations. An interactive processor operates a database through interactive processing in response to transaction requests inputted. A batch processor operates the database through batch processing in response to a batch request comprising a series of batch instructions. A log storage unit stores database logs in a time series. A log acquisition unit stores in the log storage unit a transaction log indicating the transaction every time when the interactive processor operates the database while the batch processing is not performed. And after the batch processor starts the batch processing, the log acquisition unit stores a checkpoint log indicative of the execution of the batch processing in the log storage unit.

### BACKGROUND OF THE INVENTION

1. Field of the Invention

The present invention relates to an apparatus, method and program for managing database logs, and more particularly to an apparatus, method and program for managing database logs, which are used in a system where batch processing is performed to operate a database.

2. Description of the Related Art

In a business computer system, a database is frequently updated in accordance with day-to-day tasks. If system trouble damages the database, the database has to be returned to a correct and consistent state.

We have two kinds of tasks in operating a database, on-line processing tasks and batch processing tasks, and take different techniques to restore the database depending on these two tasks.

On-Line Processing Tasks

In the on-line processing tasks, data is frequently accessed and updated in response to operational instructions, and it is important to know how to operate the data. If a database is damaged due to trouble during the on-line processing, its backup data, which was created before, is restored and then is operated based on database logs (hereinafter, referred to as archive logs), so as to restore the database.

An archive log is a log which indicates how data was updated, and is created and outputted to a log file every time when data is inserted, updated, etc., in response to an interactive user request. Therefore, even if a database is damaged, it can be restored by applying the archive logs being stored in the log file. In this on-line processing tasks, the insertion and update of data are performed in response to user requests, and therefore, if archive logs are not kept, the database may not be restored because past transactions can not be redone.

Batch Processing Tasks

Unlike the on-line processing tasks, the main task in the batch processing tasks is the insertion of high-volume data responding to a preprogrammed request for updating data. In case trouble happens, all data of a database is backed up before the batch processing. As a result, when system trouble damages the database during the batch processing, the damaged database can be restored to the state it had at a time of starting the batch processing by restoring the backup data of the database. And then, we can re-execute the batch processing from the beginning.

As stated above, a database is restored by different techniques depending on when it is damaged.

By the way, in most of database systems, we perform both the above tasks at different times, for example, the on-line processing tasks during daytime hours and the batch processing tasks during the night hours. Generally, in such systems, archive logs indicating every transaction including ones preformed during the batch processing are all stored.

That is, to return a database to a correct state on the basis of archive logs, the transactions performed on the database after the last backup should be continuously stored as archive logs. If not all archive logs are stored, proper recovery processing can not be performed.

Therefore, in the system where the on-line processing and the batch processing are performed, archive logs for all transactions performed during the batch processing as well as the on-line processing are continuously stored so as to surely restore the database.

As stated before, a high-volume data insertion is performed in the batch processing. If archive logs indicating every transaction are all stored, a lot of archive logs is created and requires a storage device with a large capacity. In addition, data is frequently input to and output from the storage device (for example, for data recording), resulting in decreasing the processing speed of the batch processing.

To avoid the inefficient processing, it can be considered that the output of archive logs may be disabled during the batch processing.

FIG. 13 shows an example of prior system operations in which the output of archive logs are temporarily disabled. For example, daily work starts with the on-line processing tasks allowing archive logs to be outputted. After the on-line processing tasks are finished, all databases (DBs) are backed up to store their backup data (step S92). After the backup processing is completed, a process to disable the output of archive logs is performed (step S93). Therefore, archive logs are not created thereafter even databases are operated by inserting data, etc.

Then, the batch processing tasks are started (step S94). When the batch processing tasks are finished, a process to enable the output of archive logs is performed (step S95), and all databases are backed up to store their backup data (step S96). When the backup processing is completed, next day's on-line processing tasks are started (step S91).

As stated above, archive logs are not created during the batch processing (in step S94). This means that no archive log indicates transactions performed during the batch processing. Therefore, all databases are backed up at the time of disabling and enabling the output of archive logs (steps S92, S96). To do so, if a database is damaged after the output of archive logs is enabled, the database can be restored to the latest state by restoring its backup data created before enabling the output and then redoing the transactions based on the archive logs stored after enabling the output.

Such prior systems, however, have following problems in temporarily disabling the output of archive logs.

One of the problems is that all databases should be backed up at the time of enabling and disabling the output of archive logs. For example, when the batch processing is performed once everyday, all databases should be backed up twice everyday. In addition, if a database comprises a plurality of resources, not only resources which were operated during the batch processing but also resources which were not operated (including ones which were only accessed but not operated) are to be backed up to store their backup data because it is not sure which resources have been operated. As a result, such systems require a memory with a large capacity to store such large-volume backup data.

Another problem is that it takes a long processing time to store large-volume backup data. This results in deteriorating the operational efficiency of the entire system.

### SUMMARY OF THE INVENTION

Taking the above into consideration, an object of the present invention is to provide an apparatus, method and program for managing database logs, providing increased operational efficiency of an entire system.

To accomplish the above object, according to the present invention, there is provided an apparatus for managing database logs. This database-log management apparatus comprises an interactive processing means for operating a database through interactive processing in response to transaction requests inputted, a batch processing means for operating the database through batch processing in response to a batch request comprising a series of batch instructions, a log storage means for storing the database logs in a time series, and a log acquisition means for storing a transaction log indicating the transaction into the log storage means every time when the interactive processing means operates the database while the batch processing is not performed, and for storing a checkpoint log indicative of the execution of the batch processing into the log storage means when the batch processing means performs the batch processing.

In addition, to accomplish the above object, there is provided a method for managing database logs. This database-log management method comprises the steps of: operating a database through interactive processing in response to transaction requests inputted; storing a transaction log indicating a transaction into a log storage means every time when the database is operated, the log storage means storing the database logs in a time series; stopping operating the database through the interactive processing; operating the database through batch processing in response to a batch request comprising a series of batch instructions; and storing a checkpoint log indicative of the execution of the batch processing into the log storage means.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention applied to this embodiment.

FIG. 2 illustrates an example of the system structure of this embodiment.

FIG. 3 illustrates an example of the hardware structure of a database server used in this embodiment.

FIG. 4 is a block diagram of the functional structure of the database server.

FIG. 5 illustrates an example of the data structure in an archive log storage unit.

FIG. 6 illustrates an example of the data structure of a log management file.

FIG. 7 illustrates an example of system operations in a case where the output of archive logs is temporally disabled.

FIG. 8 is a flowchart of processing to be performed in response to an archive log setting command.

FIG. 9 is a flowchart of processing to be performed in response to a database transaction request.

FIG. 10 is a flowchart of processing of displaying a list of updated resources.

FIG. 11 illustrates an example list of updated resources.

FIG. 12 is a flowchart of recovery processing.

FIG. 13 illustrates an example of prior system operations in a case where the output of archive logs are temporally disabled.

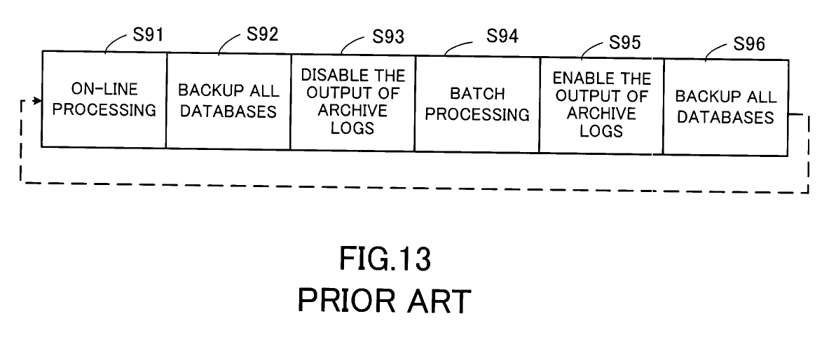

### DESCRIPTION OF THE EMBODIMENTS

Preferred embodiments of the present invention will be described below with reference to the accompanying drawings.

At first the outline of this invention applied to this embodiment will be described and then the embodiment will be explained in detail.

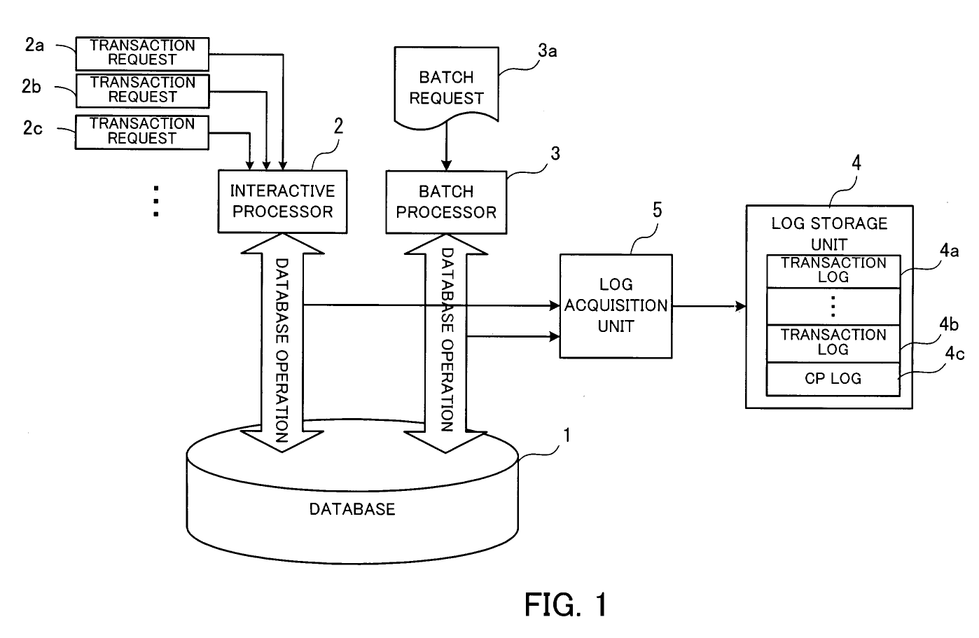

FIG. 1 is a conceptual view of this invention applied to this embodiment. A database-log management apparatus of FIG. 1 manages the database logs indicating transactions performed on a database 1, with the following functions. It should be noted that this database-log management apparatus carries out interactive processing and batch processing of the database 1 at different times.

An interactive processor 2 operates the database 1 with the interactive processing in response to inputted transaction requests 2a, 2b, 2c, . . . . This interactive processing is on-line processing which is executed in response to the transaction requests 2a, 2b, 2c, . . . transmitted from terminal devices connected via network, for example.

A batch processor 3 operates the database 1 with the batch processing in response to a batch request 3a comprising a series of batch instructions for operating the database 1.

A log storage unit 4 keeps database logs indicating transactions performed on the database 1, for example, transactions logs 4a, 4b and a checkpoint (CP) log 4c, in a time series.

A log acquisition unit 5 stores in the log storage unit 4 the transaction logs 4a, 4b indicating transactions performed on the database 1 by the interactive processor 2 while the batch processing is not executed. In addition, when the batch processor 3 performs the batch processing, for example, when the batch processor 3 firstly operates the database 1 with the batch processing, the log acquisition unit 5 stores in the log storage unit 4 the CP log 4c indicative of the execution of the batch processing.

That is, when the database-log management apparatus receives the transaction requests 2a, 2b, 2c, . . . , the interactive processor 2 operates the database 1 in response to the transaction requests and the log acquisition unit 5 stores the transaction logs 4a, 4b indicating the transactions in the log storage unit 4. Then, when the database-log management apparatus receives the batch request 3a, the batch processor 3 operates the database 1 in accordance with the batch request 3a and the log acquisition unit 5 stores in the log storage unit 4 the CP log 4c indicative of the execution of the batch processing, not a transaction log.

Such logs being stored in the log storage unit 4 allow the database 1 to be restored to the latest state when system trouble damages the database 1.

For example, if trouble happens during the batch processing, the transactions performed on the database 1 are redone on the basis of the transaction logs 4a, 4b being stored in the log storage unit 4, in a time series until the CP log 4c appears, and then the batch processing according to the batch request 3a is performed, resulting in restoring the database 1 to the latest state. As noticed, this recovery processing eliminates the need to backup the database 1 before the batch processing and therefore increases the efficiency of processing.

As another method, the log acquisition unit 5 can record a CP log in the log storage unit 4 only when the batch processor 3 actually operates the database 1. That is, no CP log in the log storage unit 4 means that the database 1 was not operated during the batch processing. This eliminates the need to backup the database 1 even the interactive processing is performed thereafter, which simplifies the operations.

In addition, if a database comprises a plurality of resources, such as data called data structure instance (DSI), the log acquisition unit 5 can store in the log storage unit 4 a CP log indicative of what a resource was operated by the batch processor 3, for each resource. Thereby, it is easy to know which resources were operated during the batch processing. Even the interactive processing is executed thereafter, only updated resources require backup, thus simplifying the operations.

By the way, in a computer system used in common by many users, the on-line processing, which is one type of interactive processing, is mostly performed. For example, the bank on-line system is the one of computer systems which execute the on-line processing and the batch processing at different times. In the bank on-line system, the on-line processing tasks are performed in response to requests from operators at branches during daytime hours, while the batch processing tasks including maintenance is performed during the night hours.

Now, the embodiment of this invention will be specifically described using an example in that the on-line processing is performed in response to transaction requests from terminal devices connected via network. In the following explanation, information recorded as a transaction log is referred to as an archive log.

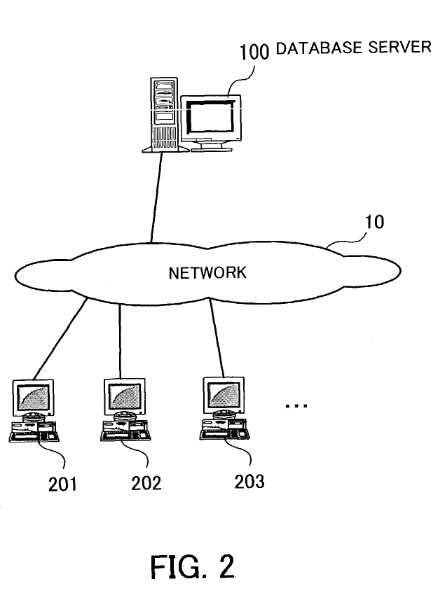

Referring to FIG. 2, an example of a system structure of this embodiment is shown. A plurality of terminal devices 201, 202, 203, . . . are connected via network to a database server 100 which is a server computer storing a database to be operated through the on-line processing tasks and batch processing tasks. The terminal devices 201, 202, 203, . . . can access the database server 100 via the network 10 to transmit transaction requests for on-line processing tasks.

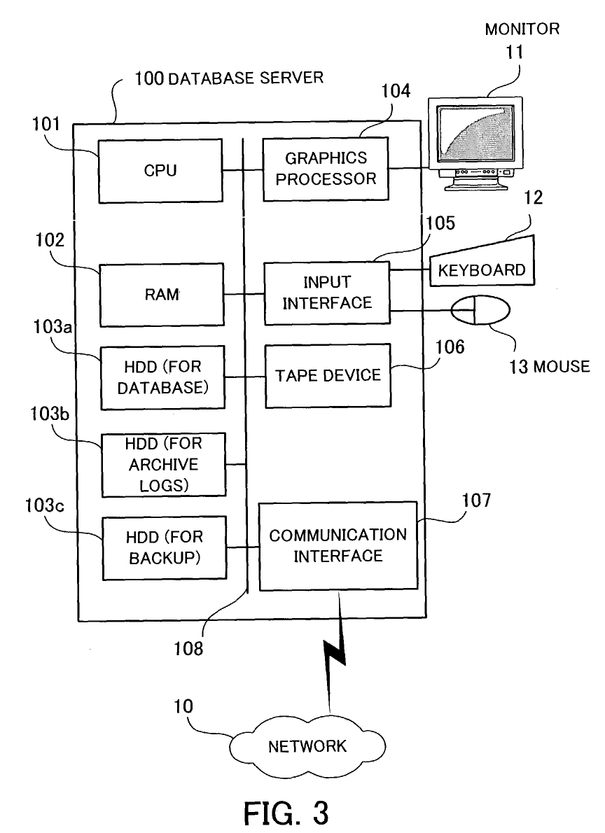

FIG. 3 shows an example of the hardware structure of the database server 100 used in this embodiment of this invention. This database server 100 is controlled by a central processing unit (CPU) 101 which is connected to a random access memory (RAM) 102, hard disk drives (HDDs) 103a, 103b, 103c, a graphics processor 104, an input interface 105, a tape device 106 and a communication interface 107 with a bus 108.

The RAM 102 temporarily stores at least part of the operating system (OS) program and application programs to be run by the CPU 101 and also stores various kinds of data for CPU use. The HDD 103a is used to store a database, the HDD 103b is used to store archive logs, and the HDD 103c is used to store backup data. All of the HDDs 103a, 103b and 103c also store the OS and application programs.

The graphics processor 104 is coupled to a monitor 11 to display images in response to commands from the CPU 101. The input interface 105 is coupled to a keyboard 12 and a mouse 13 to transfer signals from the keyboard 12 and mouse 13 to the CPU 101 through the bus 108.

The tape device 106 records backup data on a prescribed magnetic tape. This data is created through the backup processing, once recorded on the HDD 103c, and then recorded on the magnetic tape by the tape device 106.

The communication interface 107 is connected to the network 10 to communicate data with other computers (e.g., terminal devices 201, 202, 203) over the network 10.

Such hardware structure realizes the processing functions of this embodiment. It should be noted that the terminal devices 201, 202, 203, . . . can have the same hardware structure as the database server 100 shown in FIG. 3.

The next explanation is about processing functions of the database server 100 to execute the processing of this embodiment.

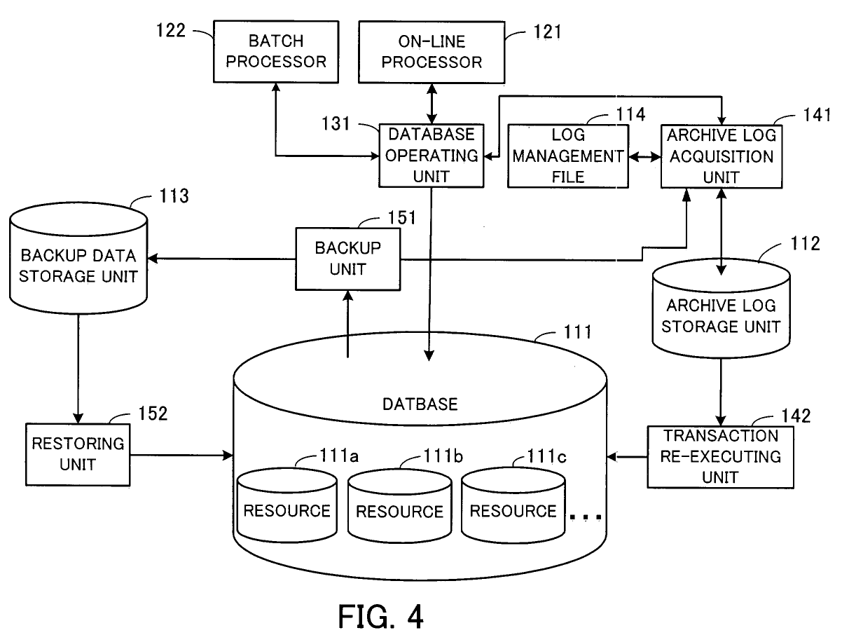

FIG. 4 is a block diagram showing the functional structure of the database server 100. This database server 100 has a database 111, an archive log storage unit 112, backup data storage unit 113, log management file 114, on-line processor 121, batch processor 122, database operating unit 131, archive log acquisition unit 141, transaction re-executing unit 142, backup unit 151 and restoring unit 152.

The database 111 comprises a plurality of resources 111a, 111b, 111c, . . . which store data corresponding to their respective items. The data is updated in various tasks.

The archive log storage unit 112 keeps archive logs according to transactions, such as the insertion of data, performed on the database 111, in a time series.

The backup data storage unit 113 keeps backup data created through the backup processing.

For example, the database 111, the archive log storage unit 112, and the backup data storage unit 113 are storages of the HDDs 103a, 103b, 103c of FIG. 3, respectively.

The log management file 114 is a file to contain various kinds of management information for archive log acquisition processing. This log management file 114 has a flag (an archive log flag) which is set to “OFF” or “ON” enabling or disabling the output of archive logs, respectively.

The on-line processor 121 is a processing function to execute the on-line processing in response to on-line transaction requests from the terminal devices 201, 202, 203, . . . , in accordance with the application program for on-line processing which is run by the database server 100.

The batch processor 122 is a processing function to perform the batch processing in response to operational instructions entered by a system operator with the keyboard 12 or the like, in accordance with the application program for batch processing which is run by the database server 100.

The database operating unit 131 inputs and retrieves data to/from the database 111 in response to requests from the on-line processor 121 and batch processor 122. For example, when receiving a request for inputting data to a certain resource, the database operating unit 131 inputs the data to the designated resource of the database 111. When receiving a request for retrieving data from a certain resource, on the other hand, the database operating unit 131 retrieves the data from the designated resource of the database 111 and transfers it to the requesting application (on-line processor 121 or batch processor 122).

The archive log acquisition unit 141 monitors transactions which are performed on the database 111 by the database operating unit 131. When the database operating unit 131 operates the database 111, the archive log acquisition unit 141 obtains and stores an archive log indicating the transaction in the archive log storage unit 112.

At this time, the archive log acquisition unit 141 checks the archive log flag set in the log management file 114 and stores the archive log only when the flag shows OFF. The archive log acquisition unit 141, however, stores a CP log in the archive log storage unit 112 when each resource is operated for the first time during the batch processing even the archive log flag shows ON. In addition, the archive log acquisition unit 141 monitors the backup processing which is carried out by the backup unit 151, and when a resource is backed up, it stores a backup log indicating that the resource was backed up even the archive log flag shows ON.

The transaction re-executing unit 142 uses the archive logs being stored in the archive log storage unit 112 in order to restore the database 111 of which the data was back to the past state due to system trouble, to the latest state. Specifically, the transaction re-executing unit 142 retrieves the archive logs from the archive log storage unit 112 in storage order and re-executes the transactions of the database 111 based on the archive logs.

The backup unit 151 backs up data of the database 111 in response to user inputs or the like. Specifically, the backup unit 151 extracts all data of the resources designated by the user, and then stores the extracted data in the backup data storage unit 113 as backup data. In a case of a request for compression and backup of data, the backup unit 151 compresses the extracted data by a prescribed data compression algorithm and then stores the compressed data as backup data.

The restoring unit 152 restores the backup data of each resource in the database 111 in response to user inputs, the backup data being stored in the backup data storage unit 113.

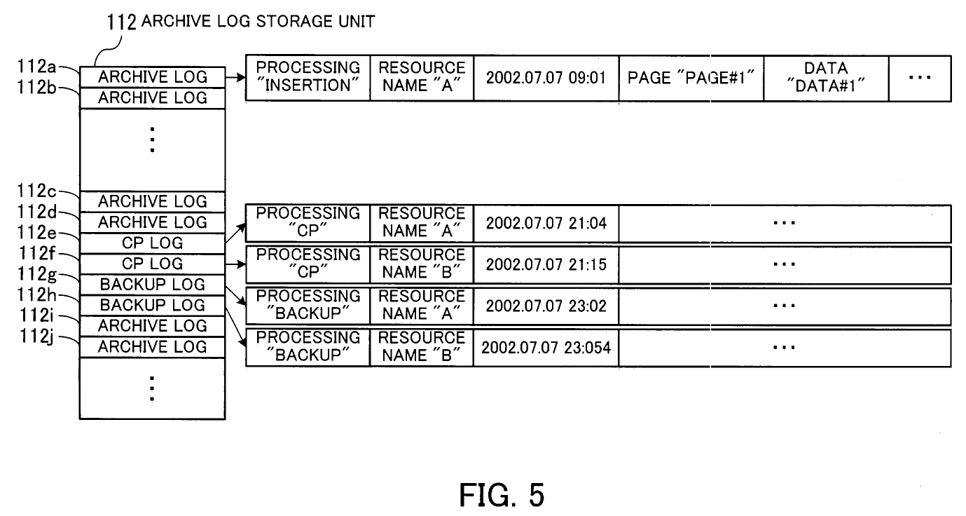

Referring now to FIG. 5, an example of the data structure of the archive log storage unit is shown. The archive log storage unit 112 keeps data such as archive logs 112a, 112b, 112c, 112d, 112i, 112j, checkpoint (CP) logs 112e, 112f, and backup logs 112g, 112h.

Each archive log 112a, 112b, 112c, 112d, 112i, 112j indicates a transaction performed on the database 111 by the database operating unit 131, and comprises the processing content, the name of an operated resource, operation time, operated page (the data of resources is managed by the page), the data content and so on. For example, the archive log 112a shows that the processing content is “insertion”, the name of an operated resource is “A”, the operation time is “at 09:01 on Jul. 7, 2002 (Jul. 7, 2002 09:01)”, the operated page is “page #1”, and the data content is “data #1”.

Each CP log 112e, 112f is indicative of that a resource was operated for the first time in response to a request from the batch processor 122, and comprises the processing content, the name of an operated resource, the operation time, etc. For example, the CP log 112e shows that the processing content is “CP”, the name of an operated resource is “A”, the operation time is “at 21:04 on Jul. 7, 2002 (Jul. 7, 2002 21:04)”. Further, the CP log 112f shows that the processing content is “CP”, the name of an operated resource is “B”, the operation time is “at 21:15 on Jul. 7, 2002 (Jul. 7, 2002 21:15)”.

Each backup log 112g, 112h is indicative of that the data of a resource was backed up, and comprises the processing content, the name of an operated resource, the operation time, etc. For example, the backup log 112g shows that the processing content is “backup”, the name of an operated resource is “A”, and the operation time is “at 23:02 on Jul. 7, 2002 (Jul. 7, 2002 23:02)”. Further, the backup log 112h shows that the processing content is “backup”, the name of an operated resource is “B”, and the operation time is “at 23:54 on Jul. 7, 2002 (Jul. 7, 2002 23:54)”.

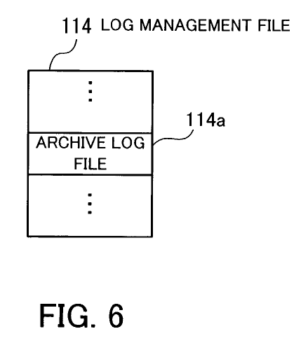

FIG. 6 shows an example of the data structure of the log management file. The log management file 114 contains various kinds of information for controlling the input and output of archive logs to/from the archive log storage unit 112, one of the information being the archive log flag 114a. This archive log flag 114a specifies whether archive logs according to requests outputted to the database operating unit 131 can be stored in the archive log storage unit 112. The archive log flag 114a shows ON to disable the output of archive logs; otherwise, it shows OFF.

The database server 100 having such structure operates following the procedure which is described below.

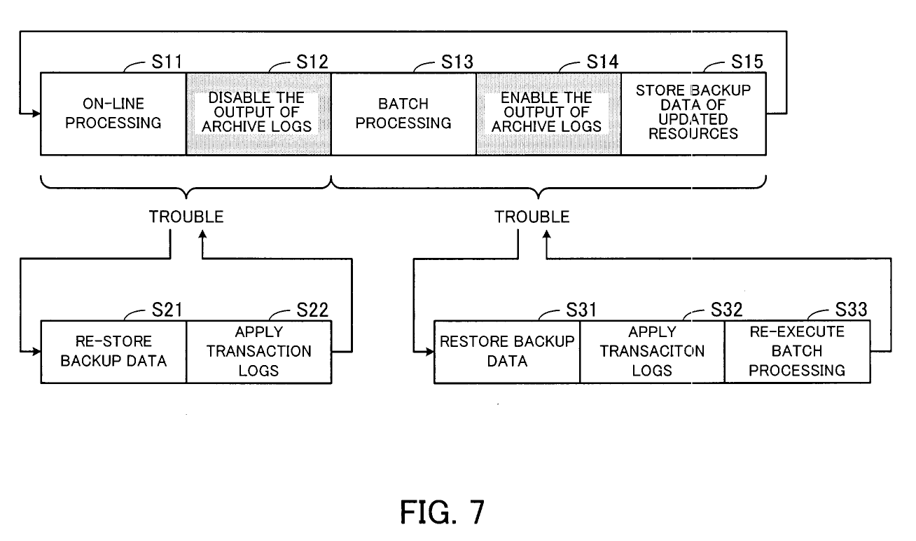

FIG. 7 shows an example of a system operation in a case of temporarily disabling the output of archive logs.

When daily business is started, the database server 100 starts the on-line processing tasks (step S11). At this time, archive logs are allowed to be outputted (the archive log flag 114a shows OFF).

During the on-line processing tasks, each terminal device 201, 202, 203, . . . sends requests to the database server 100 on the basis of user inputs. In response to the requests, the on-line processor 121 of the database server 100 performs appropriate processing. At the same time, the on-line processor 121 outputs a command for operating the database 111 (for inserting or deleting data, for example) to the database operating unit 131, the command designating a resource and data to be operated. Then, the database operating unit 131 operates the designated resource in the database 111 in accordance with the command from the on-line processor 121 (inserts data, for example).

At this time, the archive log acquisition unit 141 checks the archive log flag 114a in the log management file 114. When it is confirmed that the archive log flag 114a shows “OFF”, the archive log acquisition unit 141 creates an archive log indicating the executed transaction and stores it in the archive log storage unit 112.

When a time for the on-line processing tasks is up, the output of archive logs is disabled (step S12).

More specifically, the operator of the database server 100 enters a command for disabling the output of archive logs with the keyboard 12 or the like, so that the archive log acquisition unit 141 changes the archive log flag 114a to “ON”.

Then, the batch processing tasks is started (step S13).

Specifically, the operator of the database server 100 makes a batch request with the keyboard 12 or the like, the batch request designating a file containing a large amount of data required for the batch processing. Then, the batch processor 122 executes appropriate processing in response to the request. For example, the batch processor 122 sequentially retrieves data from the designated file and outputs to the database operating unit 131 a command for operating the database 111 according to the request from the operator. As a result, the database operating unit 131 operates the resources of the database 111 in accordance with the command from the batch processor 122 (inserts data, for example).

At this time, the archive log acquisition unit 141 obtains the command which has been outputted from the batch processor 122 to the database operating unit 131 and checks the archive log flag 114a of the log management file 114. When it is confirmed that the archive log flag 114a shows “ON”, the archive log acquisition unit 141 then detects whether the CP log for each resource to be operated in response to the command from the batch processor 122 has been stored in the archive log storage unit 112, in order to thereby determine whether the resource to be operated has been updated after the output of archive logs was disabled. If the resource has not been updated, the archive log acquisition unit 141 stores a CP log for the resource in the archive log storage unit 112.

After the batch processing is completed, the output of archive logs is enabled (step S14).

Specifically, the operator of the database server 100 enters a command for enabling the output of archive logs with the keyboard 12 or the like.

The archive log acquisition unit 141 changes the archive log flag 114a of the log management file 114 to “OFF” accordingly.

Then, the data of the updated resources is backed up (step S15).

Specifically, the backup unit 151 searches the archive log storage unit 112 for CP logs to detect updated resources. Next, the backup unit 151 displays a list of the updated resources on the monitor 11. The operator checks the list and enters a command for backing up desired resources with the keyboard 12 or the like. As a result, the backup unit 151 backs up the data of the designated resources and stores it in the backup data storage unit 113.

In this connection, the data of the database 111 is all backed up and stored in the backup data storage unit 113 periodically (every week, for example), instead of the backup of only updated resources (step S15). When the data of the whole database 111 is backed up, the archive logs which have been stored in the archive log storage unit 112 are deleted.

After the data of the resources is backed up, the above-mentioned steps S11 to S15 are repeated starting with the on-line processing tasks (step S11). If trouble occurs with the database 111, recovery processing is performed for each resource to restore the whole database 111. For example, if the resources are stored in different HDDs and some of the HDDs are in trouble, only the resources of the HDDs in trouble are restored.

To restore the database 111, different techniques are taken depending on when trouble occurs. When trouble occurs during the on-line processing (step S11) or during the processing to disable the output of archive logs (step S12), the database 111 is restored by the following technique.

First, backup data is restored (step S21).

More specifically, the operator of the database server 100 enters a command for restoring the latest backup data of a damaged resource with the keyboard 12 or the like, so that the restoring unit 152 restores the backup data in the database 111. In this connection, if the backup data is compressed data, the restoring unit 152 decompresses the data and then stores it in the database 111.

Next, the transactions are redone (step S22).

More specifically, the operator of the database server 100 enters a command for redoing the transactions which were performed on the damaged resource before the trouble, with the keyboard 12 or the like. In response to the command, the transaction re-executing unit 142 retrieves from the archive log storage unit 112 the archive logs for the damaged resource which were stored after the last backup log for the resource. Then, the transaction re-executing unit 142 re-executes the transactions based on the archive logs in storage order of the archive logs.

After the database 111 is restored, the business is resumed from the time point when the trouble happened.

On the other hand, when trouble occurs during the batch processing tasks (step S13), the processing to enable the output of archive logs (step S14) or the processing of backing up updated resources (step S15), the database 111 is restored by the following technique.

First, the backup data is restored (step S31) as in the case of step S21.

Next, the transactions are redone (step S32).

More specifically, the operator of the database server 100 enters a command for redoing the transactions which were performed on a damaged resource before trouble, with the keyboard 12 or the like. The transaction re-executing unit 142 retrieves from the archive log storage unit 112 the archive logs for the damaged resource which exist between the last backup log and the last CP log for the damaged resource. Then, the transaction re-executing unit 142 re-executes the transactions based on the archive logs in storage order of the archive logs.

After all damaged resources are restored, the batch processing tasks is re-executed from the beginning (step S33).

As a result, the database 111 is restored, and the business is resumed from the time point when the trouble happened. However, when trouble occurs during the batch processing tasks, the batch processing tasks is completed in the recovery processing and therefore the business is resumed from the next processing.

By adopting the above-mentioned processing, information required for restoring a database can be stored with minimal backup processing.

Next, the main processing which is carried out by the database server 100 of this embodiment will be explained in detail.

The first explanation is about how to set the archive log flag. The database server 100 is provided with an archive log setting command. This archive log setting command has, for example, an argument to set the archive log to “ON” or “OFF”.

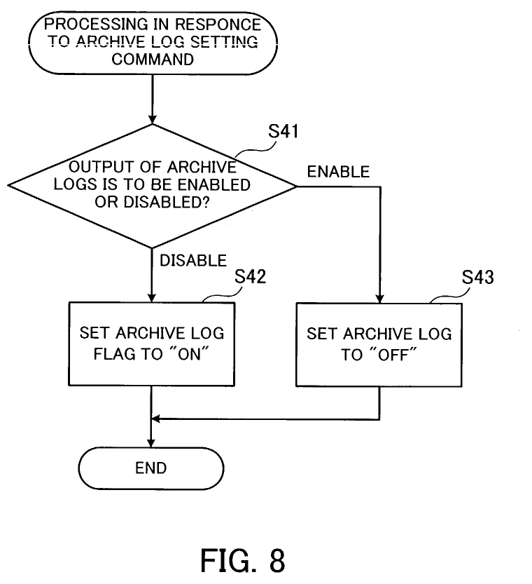

Referring to FIG. 8, a flowchart explaining how the archive log setting command sets the flag is shown.

In step S41, when an archive log setting command is entered, the archive log acquisition unit 141 determines based on, for example, the argument of the command whether the archive log setting command is a command to enable or disable the output of archive logs.

When the command is to disable the output of archive logs, then the processing proceeds to step S42; otherwise, the processing proceeds to step S43.

In step S42, the archive log acquisition unit 141 sets the archive log flag of the log management file 114 to “ON”, thus disabling the output of archive logs (excluding CP logs and backup logs) thereafter. Then, the processing is completed.

In step S43, the archive log acquisition unit 141 sets the archive log flag of the log management file 114 to “OFF”, resulting in storing an archive log every time when the database 111 is operated. Then, the processing is completed.

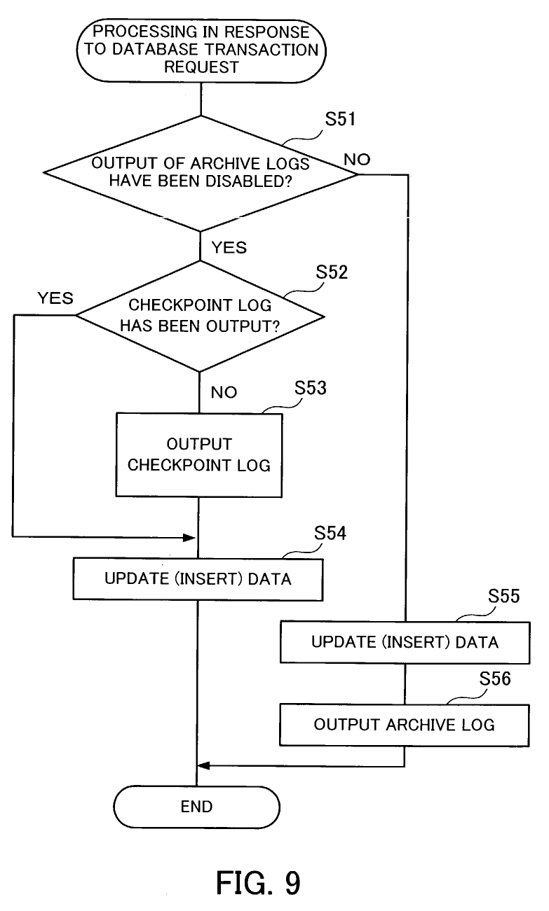

Next explanation is about processing to be carried out in response to a command for operating a database. This explanation is made following a flowchart shown in FIG. 9.

This processing is executed when the on-line processor 121 or the batch processor 122 outputs a command for operating the database 111.

In step S51, the archive log acquisition unit 141 determines based on the archive log flag 114a of the log management file 114 whether archive logs are allowed to be outputted. When the flag 114a shows “ON”, which is indicative of the stop of the output of archive logs, the processing proceeds to step S52. When the flag 114a shows “OFF”, which is indicative of the allowance of the output of archive logs, the processing proceeds to step S55.

In step S52, the archive log acquisition unit 141 determines whether a checkpoint (CP) log has been outputted. More specifically, the archive log acquisition unit 141 searches the archive log storage unit 112 for the CP log for a resource to be operated, which was stored after the last backup log for the resource. That is, the existence of the CP point log for the resource to be operated means that the CP log has been outputted.

If the CP log has been outputted, the processing proceeds to step S54; otherwise the processing proceeds to step S53.

In step S53, the archive log acquisition unit 141 stores a CP log for the resource to be operated, in the archive log storage unit 112.

In step S54, the database operating unit 131 performs the processing such as the update (insertion) of data in response to the command for operating the database 111. Then, the processing is completed.

In step S55, the database operating unit 131 performs the processing such as the update (insertion) of data in accordance with the command for operating the database 111.

In step S56, the archive log acquisition unit 141 stores an archive log corresponding to the obtained operational command, in the archive log storage unit 112. Then, the processing is completed.

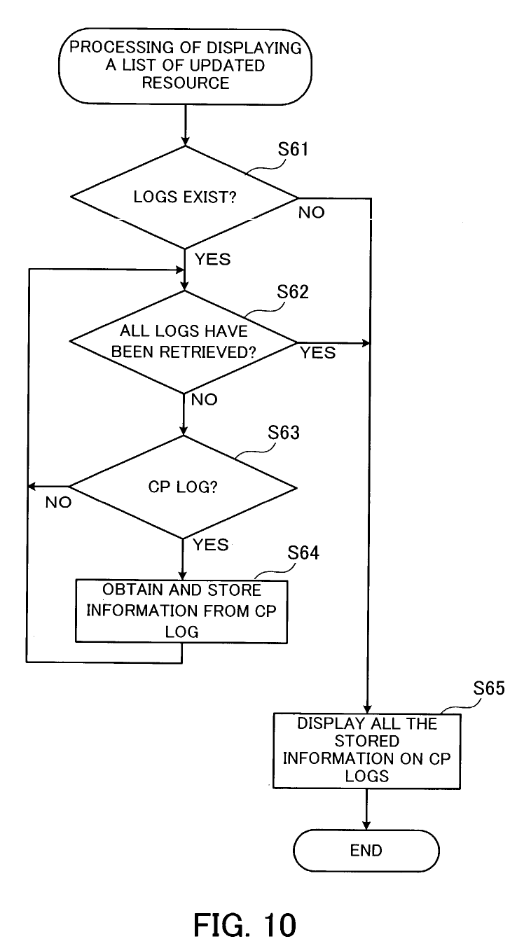

Next explanation is about processing of displaying a list of updated resources for obtaining the backup data of updated resources (step S15). This explanation is made following the flowchart of FIG. 10.

In step S61, the backup unit 151 searches the archive log storage unit 112 to determine whether logs exist. When logs do not exist, the processing proceeds to step S65; otherwise, the processing proceeds to step S62.

In step S62, the backup unit 151 determines whether it has finished the retrieval of all logs from the archive log storage unit 112. If it has finished, the processing proceeds to step S65; otherwise, the processing proceeds to step S63.

In step S63, the backup unit 151 retrieves the logs from the archive log storage unit 112 one at a time and determines whether the log is a checkpoint log. If the log is a checkpoint log, the processing proceeds to step S64; otherwise, the processing returns back to step S62.

In step S64, the backup unit 151 obtains information from the checkpoint log and stores it in the RAM 102 or the like. And then, the processing returns back to step S62.

In step S65, the backup unit 151 displays information on the checkpoint logs which were stored in the RAM 102 or the like in step S64, on the monitor 11 as a list of updated resources. Then, the processing is completed.

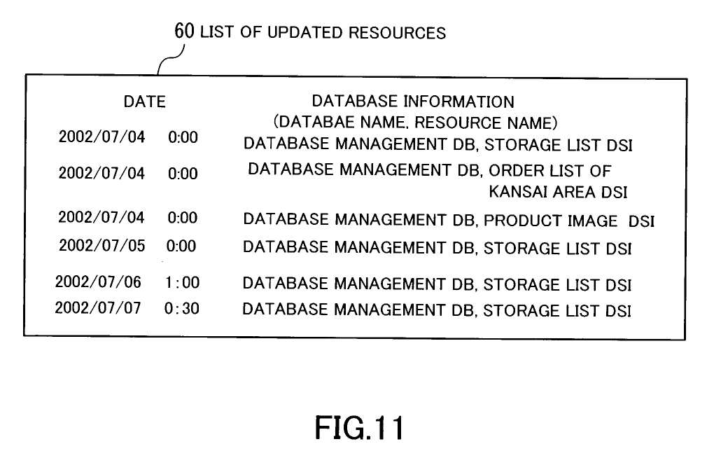

Referring now to FIG. 11, an example of a list of updated resources is shown. The list of updated resources 60 shows for each checkpoint log the date of recording the checkpoint log and database information including the names of the database and resource.

The system operator checks the list of updated resources 60 to determine which resources should be backed up. If today is Jul. 7, 2002 and the batch processing is performed everyday, he/she can know the updated resources on the basis of the database information associated with “Jul. 7, 2002”. In this example shown in FIG. 11, it is confirmed that the resource “storage list DSI” of the database “storage management DB” was updated through the batch processing at 0:30 a.m. on July 7. If the operator of the database server 100 enters a command for backing up this updated resource, the backup unit 151 backs up the data of the resource and stores it in the backup data storage unit 113.

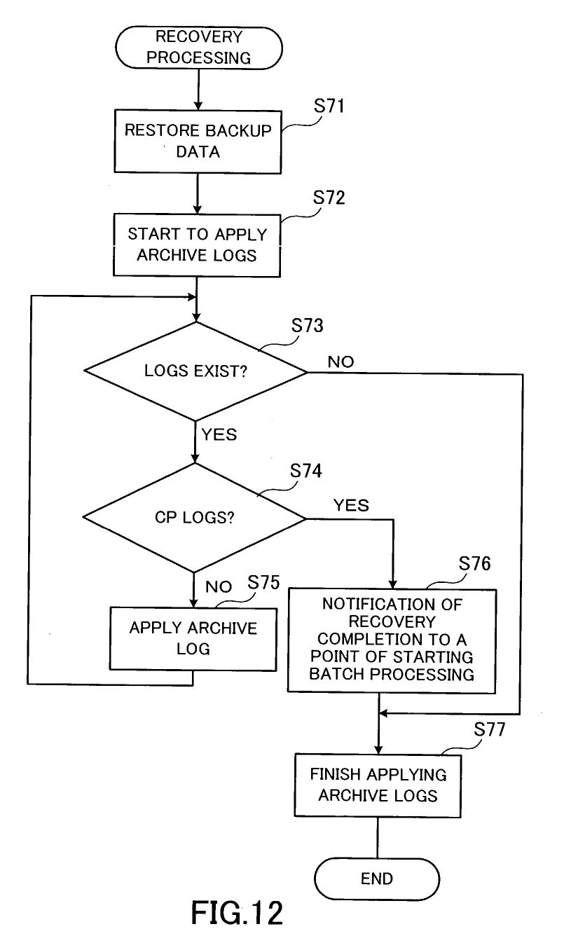

Next, recovery processing to be performed due to trouble is explained following the flowchart of FIG. 12.

In step S71, the restoring unit 152 restores the backup data of a designated resource in response to a command from the operator. The backup data is, for example, data obtained after the previous day's batch processing or data obtained at a certain time.

In step S72, the transaction re-executing unit 142 starts to apply the archive logs to the resource to be recovered.

In step S73, the transaction re-executing unit 142 determines whether logs exist in the archive log storage unit 112. If logs exist, the processing proceeds to step S74; otherwise, the processing proceeds to step S77.

In step S74, the transaction re-executing unit 142 retrieves the logs from the archive log storage unit 112 one at a time and determines whether the log is a CP log. When it is a CP log, the processing proceeds to step S76; otherwise, the processing proceeds to step S75.

In step S75, the transaction re-executing unit 142 applies archive logs. More specifically, the transaction re-executing unit 142 analyzes the archive log to detect how the data of the database 111 was operated, and then performs the same transaction on the database 111. Then, the processing returns back to step S73.

In step S76, the transaction re-executing unit 142 displays a message notifying that the database 111 has been recovered to the state it had at the time of starting the batch processing, on the monitor 11.

In step S77, the transaction re-executing unit 142 finishes applying archive logs.

If the trouble occurred during the batch processing, the batch processing is re-executed from the beginning after the above recovery processing.

If any checkpoint log is not detected during the processing of applying archive logs, the database is recognized to be the one of which the data has not been updated during the batch processing. In this case, since archive logs continue, the database can be recovered to the latest state (across a time period over which the output of archive logs is disabled).

By the way, resources operated during the batch processing can be automatically backed up on the basis of the checkpoint logs for the resources. In addition, after the recovery processing, there are two kinds of resources: resources recovered to the state it had at the time of starting the batch processing (resources for which the checkpoint logs have been detected); and resources recovered to the latest state (resources for which the checkpoint logs have not been detected). Therefore, the status of each resource after the recovery processing can be displayed.

As stated above, in this embodiment, a database can be recovered even there is a time period over which archive logs are not allowed to be outputted. This eliminates the need to backup data before the batch processing. In addition, resources operated during the batch processing can be detected based on checkpoint logs, so that only sources operated during the batch processing can be backed up.

As a result, the amount of backup data to be stored on a disk can be reduced, and therefore a storage device such as HDD can be used more efficiently. In addition, since the time for backing up data can be reduced, the system can provide the improved performance.

Note that, the above-mentioned processing functions can be realized by a computer. To do so, a program for managing database logs which contains the functions of the database-log management apparatus is installed in the computer and run. This database-log management program can be stored in a computer-readable medium such as a magnetic recording medium, optical disc, optical magnetic recording medium and a semiconductor memory. The magnetic recording media include hard disk drive (HDD), flexible disk (FD) and magnetic tape. The optical discs include Digital Versatile Disc (DVD), Digital Versatile Disc-Random Access Memory (DVD-RAM), Compact Disc Read Only Memory (CD-ROM), and Compact Disc-Recordable/Rewritable (CD-R/RW). The optical magnetic recording media include Magneto-Optical disc (MO).

To circulate the database-log management program, portable recording media such as DVDs and CD-ROMs storing the program are sold. In addition, the database-log management program can be stored in a memory of a server computer and transferred to other computers.

A computer for running the database-log management program obtains and stores in a memory thereof the database-log management program via a portable recording medium or from the server computer. Then this database-log management computer reads out the database-log management program from the memory thereof and carries out the processing based on the program. It should be noted that the computer is able to directly run the database-log management program on the portable recording medium. In addition, the computer is able to perform the processing based on the database-log management program while receiving the program from the server computer.

As described above, in this invention, not transaction logs but only checkpoint logs indicative of the execution of the batch processing are stored for a database in the log storage unit during the batch processing. Therefore, even trouble occurs during the batch processing, the database can be recovered to a state it had at the time of starting the batch processing, by re-executing the transactions based on the transaction logs before the checkpoint log. Thus the database does not require backup before the batch processing, thus providing more efficient processing.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An apparatus for managing database logs, comprising:
interactive processing means for operating a database through interactive processing in response to transaction requests inputted;
batch processing means for operating the database through batch processing in response to a batch request comprising a series of batch instructions;
log storage means for storing the database logs in a time series;
log acquisition means for storing in said log storage means a transaction log indicating the transaction every time when the interactive processing means operates the database while the batch processing is not performed, and for storing in said log storage means a checkpoint log indicative of the execution of the batch processing when said batch processing means performs the batch processing.

2. The apparatus of claim 1, wherein said log acquisition means stores the checkpoint log in the log storage means only when said batch processing means operates the database.

3. The apparatus of claim 2, wherein, in a case where the database comprises a plurality of resources, said log acquisition means stores in said log storage means a checkpoint log for each resource, the checkpoint log indicative of the execution of the batch processing for the resource by said batch processing means.

4. The apparatus of claim 3, wherein, when said batch processing means operates each of the plurality of resources for the first time, said log acquisition means stores the checkpoint log for the resource in said log storage means.

5. The apparatus of claim 3, further comprising list display means for extracting the checkpoint logs for the resources from said log storage means and displaying a list of the resources operated, based on the extracted checkpoint logs.

6. The apparatus of claim 1, further comprising transaction re-executing means for re-executing transactions performed on the database, on the basis of the transaction logs in a time series until the checkpoint log appears, the transaction logs being stored in said log storage means.

7. The apparatus of claim 1, further comprising backup means for backing up the data of the database in response to a backup instruction,
wherein said log acquisition means stores a log indicative of the execution of the backup by said backup means in said log storage means.

8. The apparatus of claim 1, wherein said interactive processing means performs on-line processing in response to transaction requests from terminal devices connected via network.

9. A method for managing database logs, comprising the steps of:
operating a database through interactive processing in response to transaction requests inputted;
storing a transaction log indicating the transaction in a log storage means every time when the database is operated, said log storage means storing the database logs in a time series;
stopping operating the database through the interactive processing;
operating the database through batch processing in response to a batch request comprising a series of batch instructions; and
storing a checkpoint log indicative of the execution of the batch processing in said log storage means.

10. A program for managing database logs, the program directing a computer to execute the steps of:
operating a database through interactive processing in response to transaction requests inputted;
storing a transaction log indicating the transaction in a log storage means every time when the database is operated, said log storage means storing the database logs in a time series;
stopping operating the database through the interactive processing;
operating the database through batch processing in response to a batch request comprising a series of batch instructions; and
storing a checkpoint log indicative of the execution of the batch processing in said log storage means.

11. A computer-readable recording medium storing a program for managing database logs, the program directing a computer to execute the steps of:
operating a database through interactive processing in response to transaction requests inputted;
storing a transaction log indicating the transaction in a log storage means every time when the database is operated, said log storage means keeping the database logs in a time series;
stopping operating the database through the interactive processing;
operating the database through batch processing in response to a batch request comprising a series of batch instructions; and
storing a checkpoint log indicative of the execution of the batch processing in said log storage means.
